(19) United States
(12) Patent Application Publication
(10) Pub. No.: US 2009/0090773 A1
(43) Pub. Date: Apr. 9, 2009

(54) ELECTRONIC PRICE TAG

(75) Inventor: Shinichi TOKUNAGA, Shizuoka (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Toshiba Tec Kabushiki Kaisha, Tokyo (JP)

(21) Appl. No.: 12/244,007

(22) Filed: Oct. 2, 2008

(30) Foreign Application Priority Data
Oct. 5, 2007 (JP) 2007-261610

(51) Int. Cl. G06K 11/00; H04Q 5/22

(52) U.S. Cl. 235/383; 340/10.6

(57) ABSTRACT

Information to identify a single operation is stored in the nonvolatile memory of a storage in response to a predetermined operation at an operating part, and price data stored in the nonvolatile memory of the storage is read in response to the predetermined operation at the operating part and a price based on the read price data is displayed on a display for a predetermined time.

### CROSS REFERENCE TO RELATED APPLICATION

The present application is based on and claims the benefit of priority of Japanese Patent Application No. 2007-261610 filed on Oct. 5, 2001, the entire contents of which is incorporated herein by reference.

### BACKGROUND OF THE INVENTION

1. Field of the Invention

The present invention relates to an electronic price tag attached to a commodity sold at a store or an electronic price tag attached to a display shelf on which the commodity is placed.

2. Discussion of the Background

In the past, electronic price tags which display commodity information based on electronic data, such as prices, have been used in stores. An electronic price tag can freely change the information which it indicates. For example, Japanese Unexamined Patent Publication No. 2001-161522 discloses a technique which changes the information indicated by an electronic price tag (an electronic inventory tag) detachably attached to a commodity display shelf, according to its position. Japanese Unexamined Patent Publication No. 2007-122288 and Japanese Unexamined Patent Publication No. 2007-114957 each describe a technique which identifies a customer by a predetermined means and changes the indicated information according to the identified customer.

Commodity sales information such as quantity sold can be easily obtained by introduction of a POS (Point Of Sales) system in the store. However, even when the POS system is introduced, it is difficult to get information on a commodity which a customer picked up but did not purchase (hereinafter called “concerned commodity”).

Information of the concerned commodity is very important for the store. The concerned commodity is not bought at present. However, because it is certain that the customer has an interest in the concerned commodity, it is highly likely that the sales of the concerned commodity will be promoted by cutting the price or offering benefits.

For this reason, Japanese Unexamined Patent Publication No. 2007-114957 describes the technique of counting how many times a commodity under the control of an electronic price tag system (electronic price tag device) are picked up by customers (see paragraph 0039 in Japanese Unexamined Patent Publication No. 2007-114957). Accordingly, a person in charge of store management can know the number of customers who get interested in the commodity and obtain information about concerned commodities, by comparison with the actual sales quantity data under the POS system. However, in the technique described in Japanese Unexamined Patent Publication No. 2007-114957, accesses to a commodity made only by customers identified by a predetermined means are counted and it is impossible to know exactly how many customers get interested in the commodity.

### BRIEF SUMMARY OF THE INVENTION

An object of the present invention is to know exactly the number of customers who get interested in a commodity, in order to obtain information on commodities which customers got interested in and picked up but did not purchase.

According to the present invention, an electronic price tag includes a display which has an information display function, an operating part which is operated by a user, and a data transceiver which is connected with a storage with a nonvolatile memory storing data including a commodity price in a rewritable manner and receives data from, and transmits data to, the storage. Here, information to identify a single operation is stored in the nonvolatile memory of the storage connected with the data transceiver in response to a predetermined operation at the operating part; and price data stored in the nonvolatile memory of the storage connected with the data transceiver is read in response to the predetermined operation at the operating part and a price based on the read price data is displayed on the display for a predetermined time.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a front view of an electronic price tag attached to clothing;

FIG. 2 is a perspective view of electronic price tags attached to display shelves;

FIG. 3 is a perspective view of an electronic price tag;

FIG. 4 is a perspective view of the electronic price tag with a USB memory inserted in a slot;

FIG. 5 is a block diagram showing the hardware configuration of the electronic price tag;

FIG. 6 is a schematic diagram showing the data structure of the USB memory;

FIG. 7A is a flowchart showing the processing sequence carried out in the electronic price tag;

FIG. 7B is a flowchart showing the processing sequence carried out in the electronic price tag;

FIG. 8 is a schematic diagram showing the data structure of the USB memory;

FIG. 9A is a flowchart showing the processing sequence carried out in the electronic price tag;

FIG. 9B is a flowchart showing the processing sequence carried out in the electronic price tag;

FIG. 10 is a perspective view of the electronic price tag with a price displayed on the LCD;

FIG. 11 is a perspective view showing that the USB memory removed from the electronic price tag is going to be connected to a PC;

FIGS. 12A to 12D are schematic diagrams showing an example of screens on the PC's LCD, in which 12A shows a commodity information screen before price change, 12B shows a price change screen, 12C shows a push count clear screen, and 12D shows a commodity information screen after price change;

FIG. 13 is a schematic diagram showing comparison between the data stored in the flash memory chip of the USB memory and the data stored in a commodity data file;

FIG. 14 is a block diagram showing the hardware configuration of an electronic price tag according to another embodiment of the present invention;

FIG. 15 is a perspective view showing that the electronic price tag can communicate data with a compact terminal according to another embodiment;

FIG. 16 is a block diagram showing the hardware configuration of the compact terminal;

FIG. 17 is a perspective view showing that an electronic price tag according to yet another embodiment of the invention can communicate data with the compact terminal;

FIG. 18 is a block diagram showing the hardware configuration of the electronic price tag according to the yet another embodiment shown in FIG. 17; and

FIG. 19 is a perspective view of an electronic price tag according to yet another embodiment with a price displayed on the LCD.

### DETAILED DESCRIPTION OF THE INVENTION

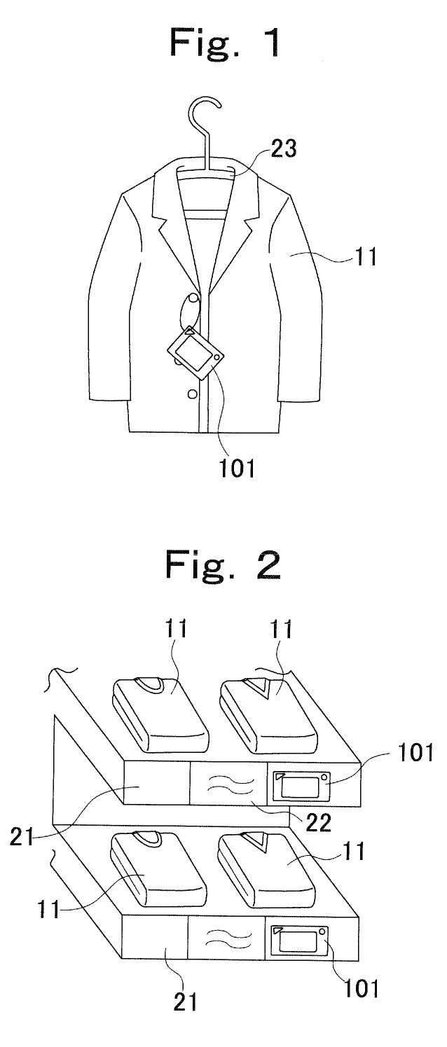

A preferred embodiment of the present invention will be described referring to FIGS. 1 to 13. This embodiment is an example of application of the invention to an electronic price tag 101 used in a store which sells clothing 11 as a commodity.

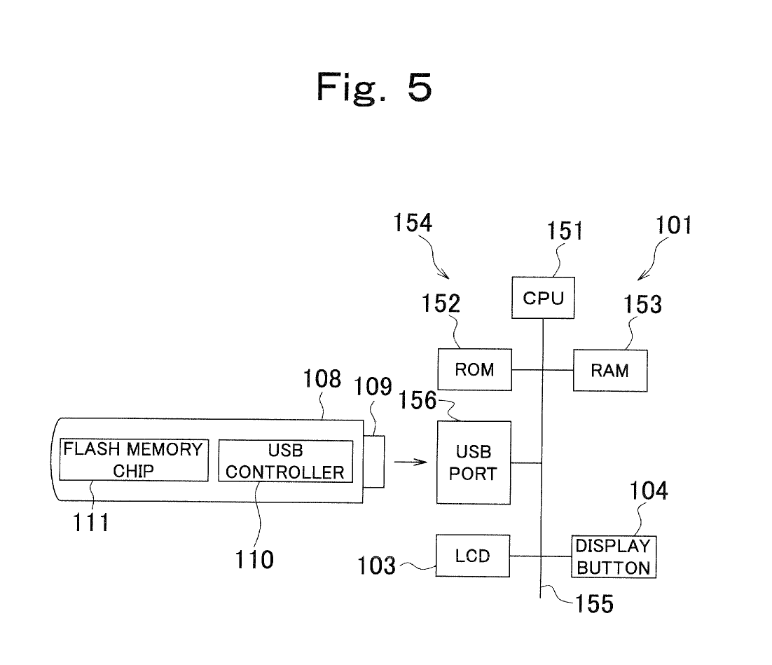

FIG. 1 is a front view of the electronic price tag 101 attached to the clothing 11. The clothing 11 is an article for sale at a store. Plural pieces of clothing 11, each on a hanger 23, are on display as shown in FIG. 1. An electronic price tag 101 is attached to each of the plural pieces of clothing 11 put on display in this way. The electronic price tag 101 is attached to part of the clothing 11 through a strap 106 (FIG. 3). The electronic price tag 101 indicates the price of the clothing 11 as will be described later.

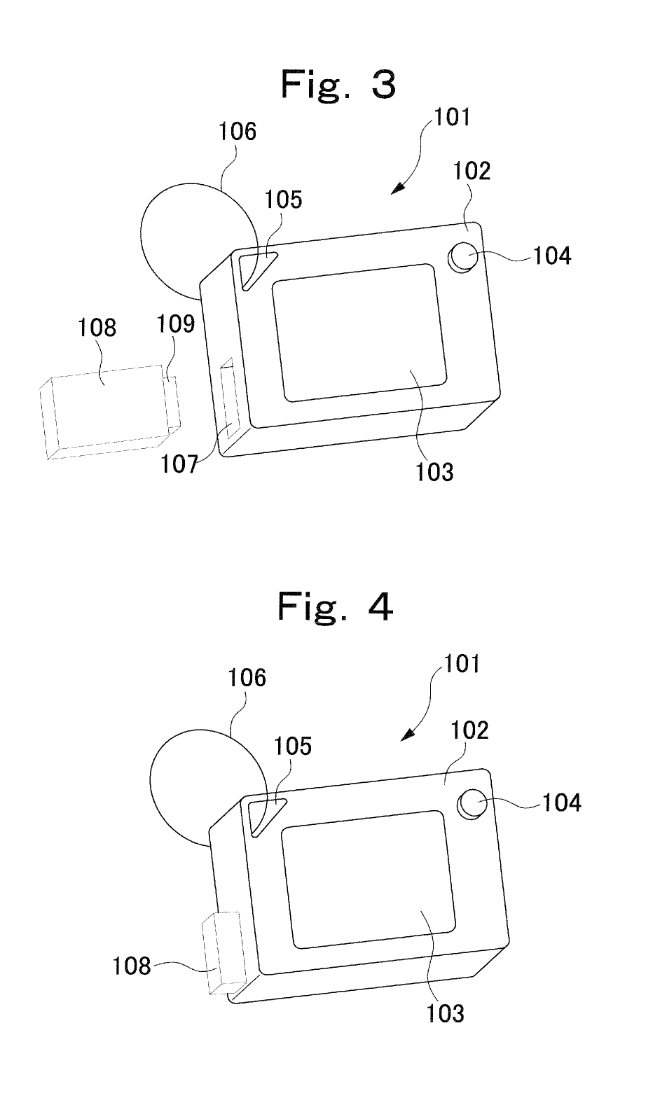

FIG. 2 is a perspective view of electronic price tags 101 attached to display shelves 21. The pieces of clothing 11 shown in FIG. 2 are folded and placed on the shelves 21. A shelf tag 22 for description of the commodity is attached on the front of each display shelf 21. An electronic price tag 101 is fixed on the right of the shelf tag 22. Each electronic price tag 101 as shown in FIG. 2 indicates the price of the plural pieces of clothing 11 placed on each display shelf 21.

FIG. 3 is a perspective view of the electronic price tag 101. The electronic price tag 101 has a rectangular parallelepiped housing 102. For example, the housing 102 is made of resin. The housing 102 has an LCD (Liquid Crystal Display) 103 in the center of one side of the housing. A battery case (not shown in the Figs.) which can house a dry battery for power supply to the electronic price tag 101 is provided on the opposite side of the LCD 103 of the housing 102. For example, the battery may be a solar cell. In this case, the housing 102 houses a solar panel. Alternatively it may be a rechargeable battery built in the housing 102. In this case, the electronic price tag 101 can be placed on a cradle as a recharger. When placed on the cradle, the battery built in the electronic price tag 101 is recharged.

At upper and left side of the LCD 103, a strap hole 105 is formed penetrating the housing 102. A strap 106 is attached to the strap hole 106 for attaching the electronic price tag 101 to the clothing 11. Therefore, the electronic price tag 101 as shown in FIG. 3 is the electronic price tag 101 attached to the clothing 11 as shown in FIG. 1.

A display button 104 is located above and right of the LCD3. The display button 104 is protruding from the surface of the housing 102 and can be pushed down by a finger.

A slot 107 into which a USB memory 108 as a portable storage is inserted is made in the left side of the housing 102.

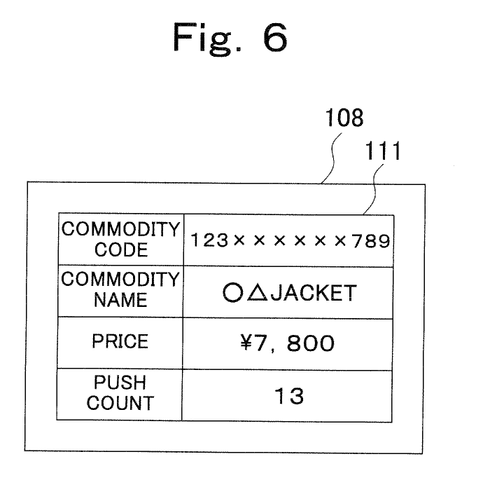

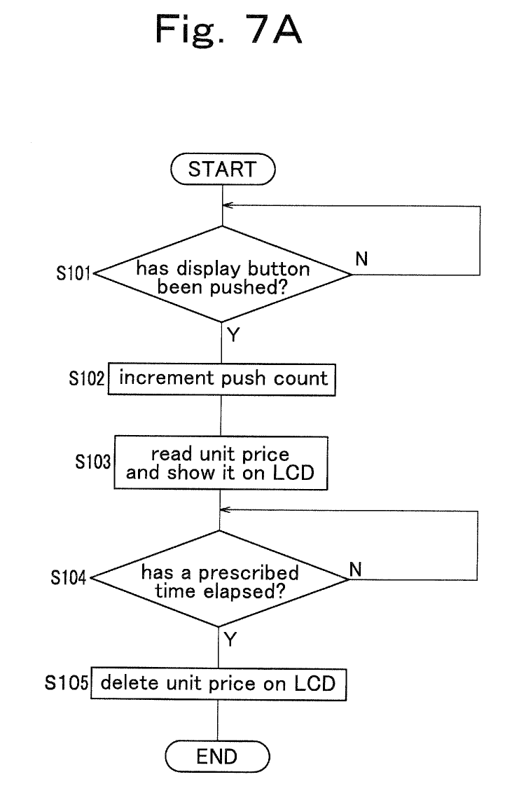

FIG. 4 is a perspective view of the electronic price tag 101 with the USB memory 108 inserted in the slot 107. Usually the electronic price tag 101 is used with the USB memory 108 inserted in the slot as shown in FIG. 4. In other words, the electronic price tag 101 is, with the USB memory 108 inserted in the slot, attached to the clothing 11 as shown in FIG. 1 or attached to the display shelf 21 as shown in FIG. 2. When the USB memory 108 is inserted in the slot 107, a large portion of its body is housed in the housing 102 while only its end part is left outside, as shown in FIG. 4. The USB memory 108 is connected to the electronic price tag 101 in this way. A USB port 156 (FIG. 5) to be connected with the USB connector 109 (FIG. 3) of the USB memory 108 is provided in the innermost part of the slot 107.

FIG. 5 is a block diagram showing the hardware configuration of the electronic price tag 101. The electronic price tag 101 incorporates a microcomputer 154. The microcomputer 154 drives and controls the LCD 103 and display button 104 through a bus line 155 and various control circuits (not shown in the Figs.). This microcomputer 154 includes a CPU 151, a ROM 152 which stores fixed data including computer programs, and a RAM 153 which stores many kinds of data in a rewritable manner, both connected to the CPU 151 through the bus line 155. The microcomputer 154 is connected with the USB port 156 through the bus line 155. The USB port 156 is connected with the USB connector 109 of the USB memory 108. The USB port 156 enables data to be transmitted to, and received from, the USB memory 108 connected with the USB connector 109. The USB memory 108 has a USB controller 110 and a flash memory chip 111 which is a nonvolatile memory, in a plastic case. The nonvolatile memory of the USB memory 108 is not limited to the flash memory chip 111 but may be, for example, an RFID tag or HDD.

The USB controller 110 controls data writing to the flash memory chip 111. The microcomputer 154 accesses the USB memory 108 and writes data to the flash chip memory 111 or reads data from it. The electronic price tag 101 is driven by power supplied from the dry battery in the battery case.

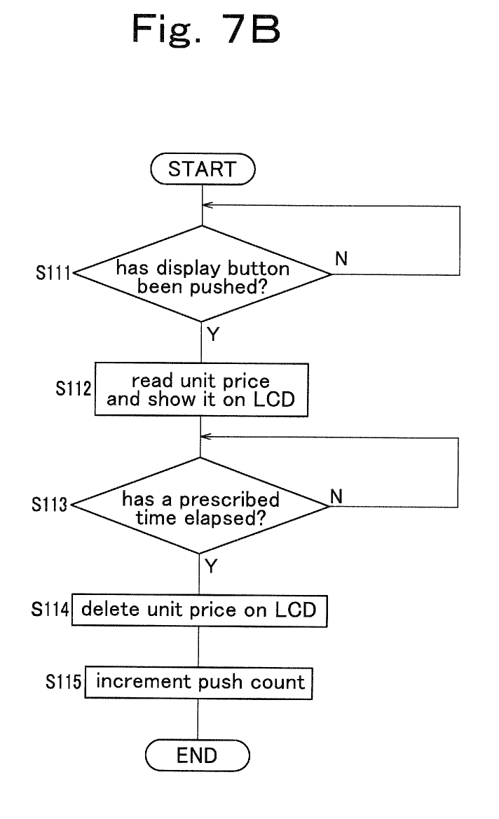

FIG. 6 is a schematic diagram showing the data structure of the USB memory 108. The flash memory chip 111 of the USB memory 108 has various memory areas. The memory areas of the flash chip memory 111 store data such as “commodity code,” “commodity name,” “price,” and “push count.” “Commodity code” is a code which identifies a commodity. “Commodity name” is the name of the commodity identified by the commodity code and “price” is its sales price. “Push count” is the number of times the display button 104 as an operating part has been operated or pushed. It is needless to say that other kinds of data may be stored in the flash memory chip 111.

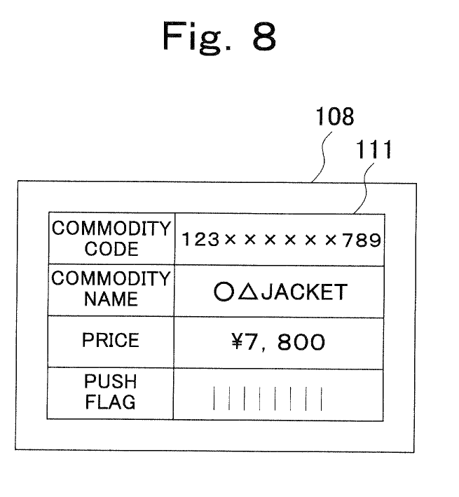

Next, the sequence in which the microcomputer 154 of the electronic price tag 101 carries out a processing sequence according to the computer program stored in the ROM 152 will be explained referring to FIGS. 7A and 7B.

FIG. 7A is a flowchart showing the processing sequence carried out in the electronic price tag 101. The microcomputer 154 of the electronic price tag 101 waits for a determination that the display button 104 has been pushed (Step S101). At this time, no screen information is given to the LCD 103.

As the display button 104 is pushed, a given signal is sent to the microcomputer 154. In the state that the signal has not been input (N at Step S101), the microcomputer 154 waits until input of the signal. Upon receipt of the signal, the microcomputer 154 determines whether or not the display button 104 has been pushed. As it is determined that the display button 104 has been pushed (Y at Step S101), the microcomputer 154 accesses the USB memory 108 connected with the USB port 156 and increments the “push count” stored in the flash memory chip 111 (Step S102). For instance, if the stored “push count” is 13, the “push count” for the display button 104 becomes 14.

Next, the microcomputer 154 reads “price” data stored in the flash memory chip 111 and gives the LCD 103 screen display information based on the price data. Thus the “price” stored in the flash memory chip 111 appears on the LCD 103 (Step S103). It is not until this time that the LCD 103 displays the price. If the stored price is ¥7,800, the LCD 103 displays ¥7,800.

Then the microcomputer 154 of the electronic price tag 101 determines if the predetermined time has elapsed (Step S104). If it is determined that the predetermined time has not elapsed (N at Step 104), the microcomputer 154 repeats the determination until the predetermined time has elapsed. After display of the price (Step S103), if the predetermined time has elapsed (Y at Step S104), the microcomputer 154 deletes the screen display information, which has given to the LCD 103. Consequently the unit price displayed on the LCD 103 disappears (Step S105).

Alternatively the microcomputer 154 may increment the “push count” stored in the flash memory chip 111 of the USB memory 108 after a lapse of the predetermined time (for example, three minutes) such that the LCD 103 displays a unit price (referring to FIG. 7B).

FIG. 7B is a flowchart showing another embodiment of the processing sequence carried out in the electronic price tag 101. The microcomputer 154 of the electronic price tag 101 waits for a determination that the display button 104 has been pushed (Step S111). At this time, no screen information is given to the LCD 103.

As the display button 104 is pushed, a given signal is sent to the microcomputer 154. In the state that the signal has not been input (N at Step S111), the microcomputer 154 waits until input of the signal. Upon receipt of the signal, the microcomputer 154 determines whether or not the display button 104 has been pushed. As it is determined that the display button 104 has been pushed (Y at Step S111), the microcomputer 154 reads “price” data stored in the flash memory chip 111 and gives the LCD 103 screen display information based on the price data. Thus the “price” stored in the flash memory chip 111 appears on the LCD 103 (Step S112). If the stored price is ∓7,800, the LCD 103 displays ∓7,800. Then the microcomputer 154 of the electronic price tag 101 determines if the predetermined time has elapsed (Step S113). If it is determined that the predetermined time has not elapsed (N at Step S113), the microcomputer 154 repeats the determination until the predetermined time has elapsed. After display of the price (Step S112), if the predetermined time has elapsed (Y at Step S113), the microcomputer 154 deletes the screen display information, which has given to the LCD 103. Consequently the unit price displayed on the LCD 103 disappears (Step S114). After that, the microcomputer 154 accesses the USB memory 108 connected with the USB port 156 and increments the “push count” stored in the flash memory chip 111 (Step S115). For instance, if the stored “push count” is 13, the “push count” for the display button 104 becomes 14.

As a consequence, the influence of mischievous pushes on the push count is avoided. For example, even if the display button 104 is pushed successively while the LCD 103 displays a unit price, no pushing operation is counted as a push while the LCD 103 displays a unit price. Therefore, the push count stored in the flash memory chip 111 of the USB memory 108 is kept correct without being affected by any mischievous push.

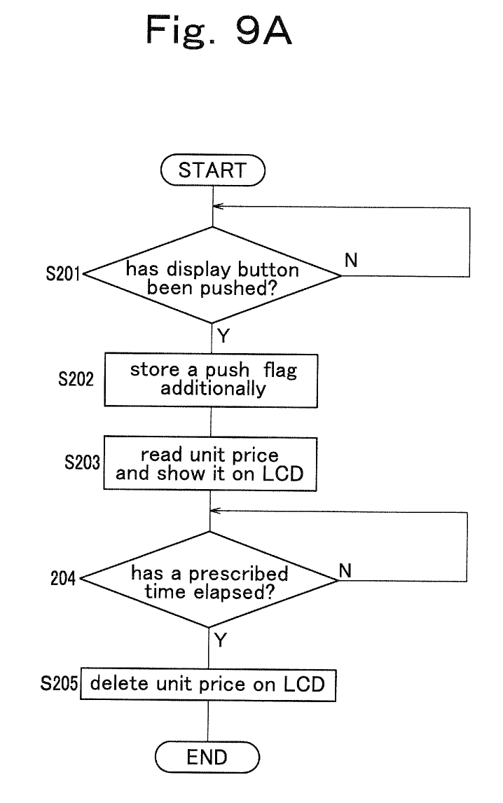

Alternatively the USB memory 108 may store a “push flag” instead of “push count” as information to identify a single operation. FIG. 8 is a schematic diagram showing the data structure of the USB memory 108 in a case that the USB memory 108 stores “push flags.” In this case, the memory areas of the flash memory chip 111 of the USB memory 108 store data such as “commodity code,” “commodity name,” “price,” and “push flag.” “Push flag” is a status signal to identify a single operation which is additionally stored in a memory area of the RFID tag 411 each time the display button 104 is operated.

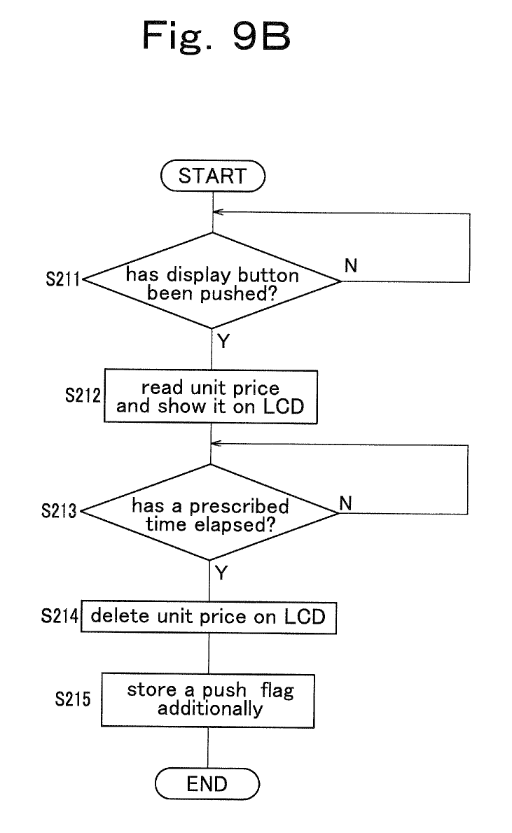

FIG. 9A is a flowchart showing the processing sequence carried out in the electronic price tag 101 in a case that the USB memory stores “push flags.” The microcomputer 154 of the electronic price tag 101 waits for a determination that the display button 104 has been pushed (Step S201). At this time, no screen information is given to the LCD 103. As the display button 104 is pushed, a given signal is sent to the microcomputer 154. In the state that the signal has not been input (N at Step S201), the microcomputer 154 waits until input of the signal. Upon receipt of the signal, the microcomputer 154 determines whether or not the display button 104 has been pushed. As it is determined that the display button 104 has been pushed (Y at Step S201), the microcomputer 154 accesses the USB memory 108 connected with the USB port 156 and stores an additional “push flag” in a memory area (Step S202). For instance, if the total number of the “push flag” in the flash memory chip 111 is 13, the total number of the “push flag” for the display button 104 becomes 14.

Next, the microcomputer 154 reads “price” data stored in the flash memory chip 111 and gives the LCD 103 screen display information based on the price data. Thus the “price” stored in the flash memory chip 111 appears on the LCD 103 (Step S203). It is not until this time that the LCD 103 displays the price. If the stored price is ∓7,800, the LCD 103 displays ∓7,800.

Then the microcomputer 154 of the electronic price tag 101 determines if the predetermined time has elapsed (Step S204). If it is determined that the predetermined time has not elapsed (N at Step 204), the microcomputer 154 repeats the determination until the predetermined time has elapsed. After display of the price (Step S203), if the predetermined time has elapsed (Y at Step S204), the microcomputer 154 deletes the screen display information, which has given to the LCD 103. Consequently the unit price displayed on the LCD 103 disappears (Step S205).

Alternatively the microcomputer 154 may stores an additional “push flag” in the flash memory chip 111 of the USB memory 108 after a lapse of the predetermined time (for example, three minutes) such that the LCD 103 displays a unit price (referring to FIG. 9B).

FIG. 9B is a flowchart showing another embodiment of the processing sequence carried out in the electronic price tag 101 in a case that the USB memory stores “push flags.” The microcomputer 154 of the electronic price tag 101 waits for a determination that the display button 104 has been pushed (Step S211). At this time, no screen information is given to the LCD 103.

As the display button 104 is pushed, a given signal is sent to the microcomputer 154. In the state that the signal has not been input (N at Step S211), the microcomputer 154 waits until input of the signal. Upon receipt of the signal, the microcomputer 154 determines whether or not the display button 104 has been pushed. As it is determined that the display button 104 has been pushed (Y at Step S211), the microcomputer 154 reads “price” data stored in the flash memory chip 111 and gives the LCD 103 screen display information based on the price data. Thus the “price” stored in the flash memory chip 111 appears on the LCD 103 (Step S212). If the stored price is ¥7,800, the LCD 103 displays ␣7,800. Then the microcomputer 154 of the electronic price tag 101 determines if the predetermined time has elapsed (Step S213). If it is determined that the predetermined time has not elapsed (N at Step S213), the microcomputer 154 repeats the determination until the predetermined time has elapsed. After display of the price (Step S212), if the predetermined time has elapsed (Y at Step S213), the microcomputer 154 deletes the screen display information, which has given to the LCD 103. Consequently the unit price displayed on the LCD 103 disappears (Step S214). After that, the microcomputer 154 accesses the USB memory 108 connected with the USB port 156 and stores an additional “push flag” in a memory area (Step S215). For instance, if the total number of the “push flag” in the flash memory chip 111 is 13, the total number of the “push flag” for the display button 104 becomes 14.

As a consequence, the influence of mischievous pushes on the push count is avoided. For example, even if the display button 104 is pushed successively while the LCD 103 displays a unit price, no pushing operation is counted as a push while the LCD 103 displays a unit price. Therefore, the push count stored in the flash memory chip 111 of the USB memory 108 is kept correct without being affected by any mischievous push.

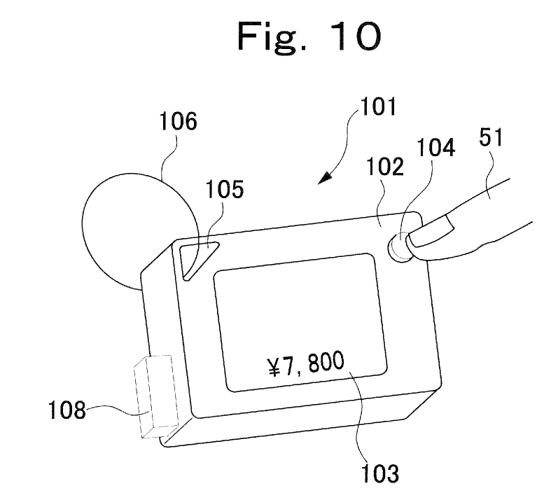

FIG. 10 is a perspective view of the electronic price tag 101 with a price displayed on the LCD 103. The figure shows that a customer's finger 51 is pushing the display button 104. Consequently, as explained in reference to FIGS. 7A and 7B, the price data is read from the USB memory 108 and the price based on the read data is displayed on the LCD 103. In other words, the LCD 103 does not show a commodity price (FIG. 4) until the display button 104 is pushed. Almost all customers that consider purchasing the commodity will attempt to know its price, which is the greatest concern for purchasing. Therefore, the customers will push the display button 104 of the electronic price tag 101 attached to the commodity. Thus, by pushing the display button 104 and looking at the price displayed on the LCD 103, the customer can know the price of the clothing 11 to which the electronic price tag 101 is attached.

In order to prevent the customer from feeling embarrassed by the absence of price indication on the clothing 11, a label or the like which bears guidance to push the display button 104 for price indication may be affixed to the housing 102.

The price displayed on the LCD 103 disappears after a predetermined time has elapsed. This predetermined time should be enough for a customer to check the price shown on the LCD 103 correctly (for example, 3 minutes). Therefore, the display button 104 of the electronic price tag 101 is pushed by each customer who likes to know the price of the clothing 11 to which the electronic price tag 101 is attached. In other words, pushing operation of the display button 104 of the electronic price tag 101 is performed by each customer who considers buying the clothing 11.

In the case that “push count” is employed as information to identify a single operation to be stored in the USB memory 108, the “push count” for the display button 104 is incremented each time the button 104 is pushed, as described above in reference to FIGS. 7A and 7B. The particular situation of the clothing in the store can be grasped by referring to the push count. More specifically, if the “push count” stored in the USB memory of the electronic price tag 101 attached to a certain article of clothing 11 is larger than the average, it can be said that it is very likely that the article of clothing 11 is a commodity which many customers get interested in but did not buy (“concerned commodity”). The average push count is empirically calculated according to various factors such as store, sales room, selling period, and type of commodity.

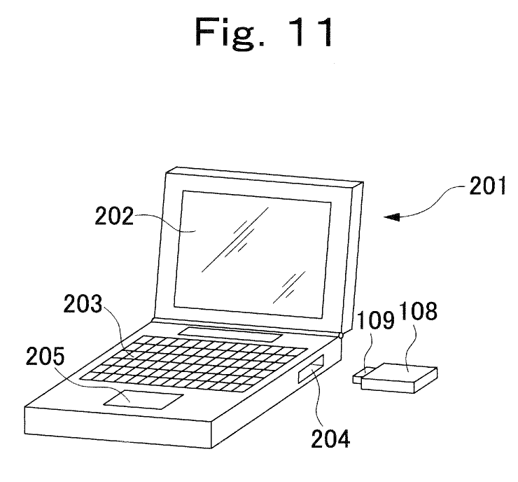

In order to check the push count stored in the flash memory chip 111 of the USB memory 108, a person in charge of store management removes the USB memory 108 from the electronic price tag 101 and connects it to a PC 201 (FIG. 11).

FIG. 11 is a perspective view showing that the USB memory 108 removed from the electronic price tag 101 is going to be connected to the PC 201. The PC 201 as shown in FIG. 11 is a so-called notebook size personal computer having a case which can be opened and closed freely. The notebook size personal computer includes an LCD 202 which displays information, a keyboard 203 which is used to enter information, and a track pad 205 which is used to move the mouse pointer on the screen of the LCD 202. The PC 201 has, on its right side, a USB port 204 to which the USB connector 109 of the USB memory 108 can be connected. The PC 201 should meet the USB mass storage class specification or be a PC on which an OS (Operating System) suitable for that class runs. Therefore, the PC 201 does not require installation of a driver and can recognize the USB memory 108 connected to the USB port 204 as a storage only through its standard functions. The other elements of the PC 201 are the same as those of ordinary notebook size personal computers and their descriptions are omitted here.

The microcomputer (not shown in the Figs.) of the PC 201 accesses the USB memory 108 connected to it and reads the data stored in the flash memory chip 111 and supplies, to the LCD 202, screen display information based on the read data.

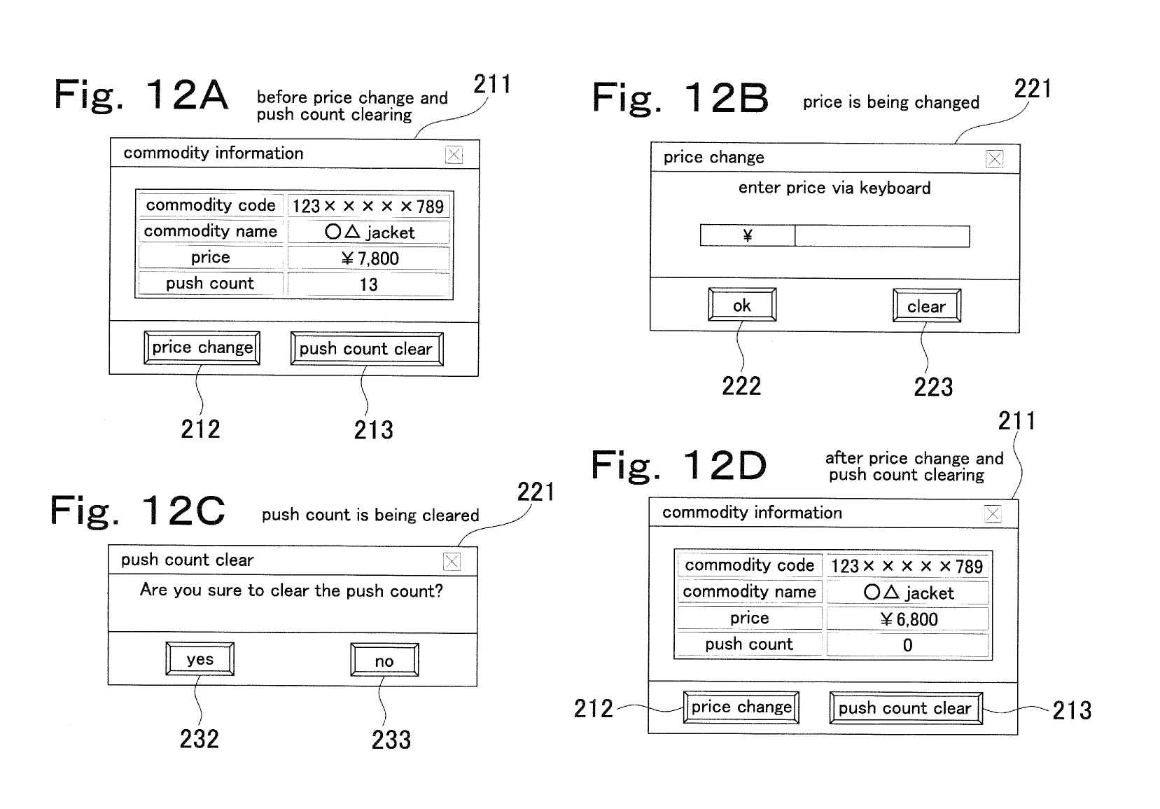

FIGS. 12A to 12D are schematic diagrams showing an example of screens on the LCD 202 of the PC 201. The microcomputer (not shown in the Figs.) of the PC 201 reads the data stored in the flash memory chip 111 and supplies a commodity information screen 211 as shown in FIG. 12A to the LCD 202 (not shown in FIGS. 12A to D). The commodity information screen 211 displays the same content as the data stored in the flash memory chip 111 of the USB memory 108. In other words, the commodity information screen 211 displays data such as “commodity code,” “commodity name,” “price,” and “push count.”

As illustrated in FIG. 12A, the commodity information screen 211 contains a price change button 212 labeled “PRICE CHANGE” and a push count clear button 213 labeled “PUSH COUNT CLEAR” in its lower part. If the push count displayed on the commodity information screen 211 is larger than the average and it is determined that the commodity concerned is a “concerned commodity” and some price reduction encourages customers to buy it, the operator moves the mouse pointer to the price change button 212 using the track pad 205 and makes a click. As the price change button 212 is clicked, a price change screen 221 appears on the LCD 202 as shown in FIG. 12B. Consequently it becomes possible to change the price stored in the flash memory chip 111 of the USB memory 108. The price is changed by entering a new price via the keyboard 203. The entered price is cleared by clicking the clear button 223 on the price change screen 221, and by clicking the OK button 222, the newly entered price is written and the commodity information screen 211 is restored on the LCD 202.

When the price is changed, the push count must be cleared. By clicking the push count clear button 213 on the restored commodity information screen 211, a push count clear screen 231 appears on the LCD 202 as shown in FIG. 12C. The push count clear screen 231 contains wording such that “Are you sure to clear the push count?”. Thus, PC 201 asks the operator of the PC 201 whether to clear the push count. If a clear reject button 233 labeled “NO” is clicked on the push count clear screen 231, the push count stored in the flash memory chip 111 is not cleared; if a clear button 232 labeled “YES” is clicked, the push count stored in the flash memory chip 111 is cleared.

FIG. 12D shows the commodity information screen 211 after price change and push count clearing. By looking at the price change screen 221, the operator of the PC 201 can easily know that the data in the flash memory chip 111 of the USB memory 108 has been changed. In the example shown in FIGS. 12A to D, the price is changed from 7800 yen to 6800 yen and push count 43 is cleared and the push count becomes 0.

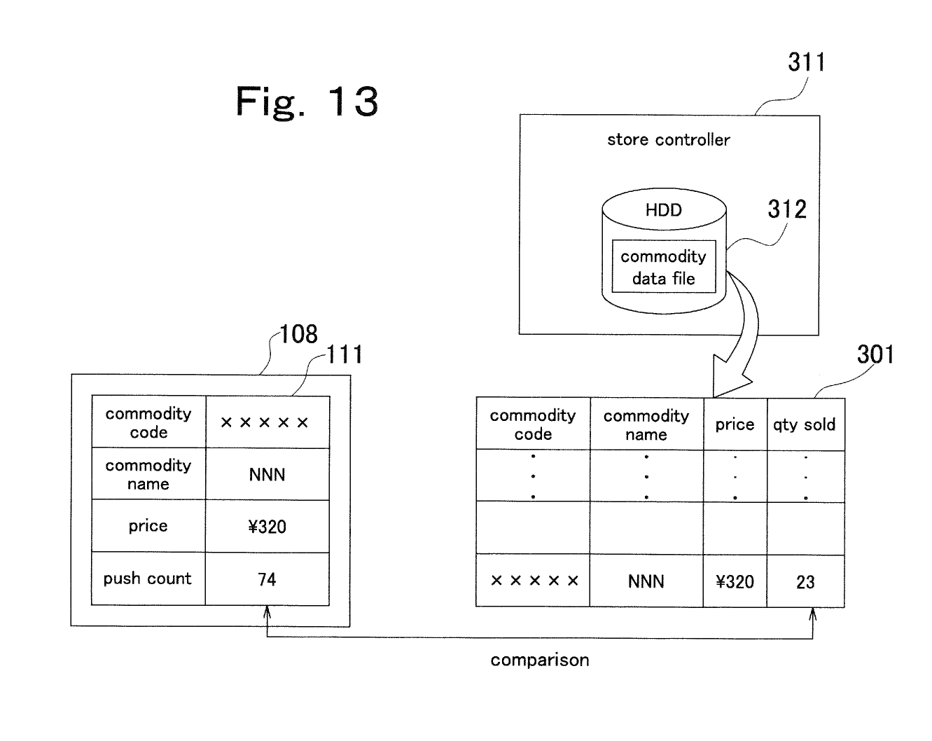

The push count stored in the flash memory chip 111 of the USB memory 108 can be compared not only with the empirically calculated average but also with the actual quantity sold as data under the POS system (not shown in the Figs.). The actual quantity sold is stored and managed in a commodity data file 301 stored in a HDD 312 (FIG. 13) of a store controller 311 (FIG. 13) installed in the store's backyard or the like. It is also possible to store the commodity data file 301 in a host computer installed in the store's general management room.

FIG. 13 is a schematic diagram showing comparison between the data stored in the flash memory chip 111 of the USB memory 108 and the data stored in the commodity data file 301. The PC 201 is connected with the store controller 311 through LAN or the like so that they can communicate data with each other. By operating the PC 201 with a predetermined procedure, data can be loaded from the commodity data file 301 in the HDD 312 of the store controller 311. The loaded data is displayed on the LCD 202 of the PC 201. At the same time the data in the USB memory 108 is also shown on the LCD 202. The former data concerns the actual quantity sold and the latter data is “push count.” As for the same commodity code or same kind of commodity, the quantity sold and the push count are compared and if the push count is far larger than the quantity sold, it may be determined that the commodity is a “concerned commodity.”

Also in the case that “push flag” is employed as information to identify a single operation to be stored in the USB memory 108, the particular situation of the clothing 11 in the store can be known by referring to the total number of push flags stored in the USB memory 108 and comparing it with the actual quantity sold. In this example as well, the commodity information screen 211 of the PC 201 displays “commodity code,” “commodity name,” “price,” and “push count” based on the data stored in the USB memory 108 (FIG. 12A). The “push count” shown here is the total number of push flags which the microcomputer 154 of the PC 201 has counted and calculated from the sum of push flags stored in the USB memory 108. In this example, the “clear flag” data stored in the USB memory 108 is cleared by selecting the clear button 232 labeled “YES” on the push count clear screen 231.

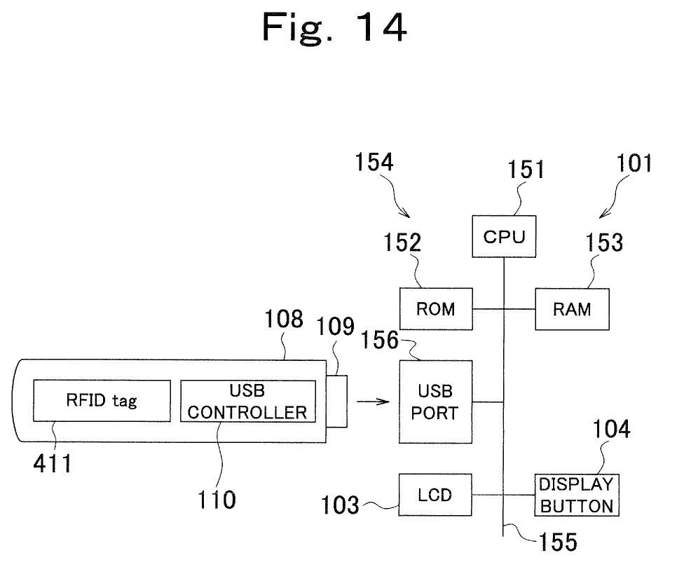

Next, another embodiment of the present invention will be described referring to FIGS. 14 to 16. The same elements as those in the aforementioned or first embodiment are designated by the same reference numerals and their descriptions are omitted.

FIG. 14 is a block diagram showing the hardware configuration of an electronic price tag 101 according to the second embodiment of the present invention. The electronic price tag 101 in this embodiment employs an RFID tag 411 instead of the flash memory chip 111. The RFID tag 411 includes an IC chip with a memory (not shown in the Figs.) and an antenna which enables wireless data communications (not shown in the Figs.). The USB controller 110, which is connected with the IC chip by wire (not shown the Figs.), controls data writing to the IC chip. The microcomputer 154 accesses the USB memory 108 and writes data to, and reads data from, the IC chip.

The data stored in the RFID tag 411 is the same as the data stored in the flash memory chip 111 in the first embodiment (FIG. 6). Again the electronic price tag 101 in this embodiment carries out the series of steps as described in reference to FIG. 7A or FIG. 7B, like the electronic price tag 101 in the first embodiment.

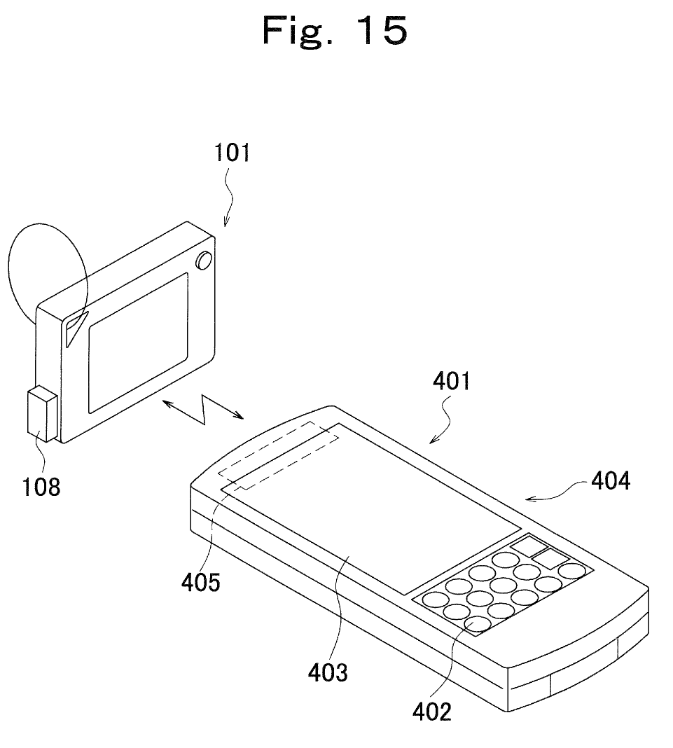

In order to check the push count stored in the RFID tag 411 of the USB memory 103, a person in charge of store management uses a compact terminal 401 (FIG. 15) equipped with an RFID tag reader/writer 405 which can read data from, and write data to, the RFID tag 411.

FIG. 15 is a perspective view showing that the electronic price tag 101 can communicate data with the compact terminal 401. The compact terminal 401 has a case 404 in which a keyboard 402 and an LCD 403 for information display are arranged along its long axis. A touch panel (not shown in the Figs.) lies over the LCD 403. An RFID tag reader/writer 405 is incorporated in one end of the compact terminal 401.

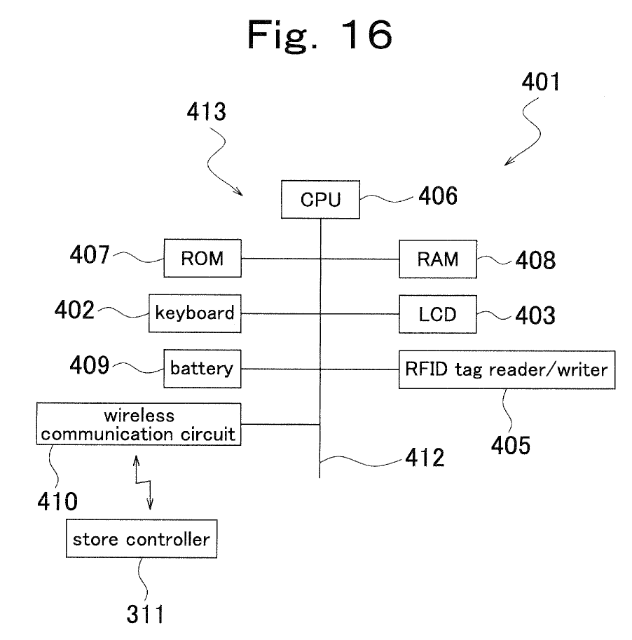

FIG. 16 is a block diagram showing the hardware configuration of the compact terminal 401. The compact terminal 401 incorporates a CPU 406. The CPU 406 is connected with a ROM 407 which stores programs such as operating programs and a RAM 408 which stores various kinds of data in a rewritable manner through a bus line 412. The CPU 406, ROM 407, and RAM 408 constitute a control section 413. Furthermore, the CPU 406 is also connected with a keyboard 402, an LCD 403, a battery 409, an RFID tag reader/writer 405, and a wireless communication circuit 410 for communication with a store controller 311 through the bus line 412. Wireless communications between the RFID tag reader/writer 405 and the RFID tag 411 may be made by either of the following methods: capacitive coupling, electromagnetic coupling, electromagnetic induction, and microwave communication. In this embodiment, short-range wireless communications are made between the RFID tag reader/writer 405 and RFID tag 411, for example, by electromagnetic induction using a frequency band of 13.56 MHz.

The control section 413 of the compact terminal 401 drives and controls the RFID tag reader/writer 405 according to operation of the keyboard 402 and acquires data stored in the IC chip by short-range wireless communication with the RFID tag 411. In addition, the control section 413 supplies screen display information based on the acquired data to the LCD 403. Since the screens here are the same as those on the LCD 202 in the first embodiment (FIGS. 12A to D), an explanation will be given below referring to FIGS. 12A to D.

The control section 413 of the compact terminal 401 acquires data stored in the RFID tag 411 and supplies screen display information as a commodity information screen 211 shown in FIG. 12A to the display with a touch panel (not shown in FIGS. 12A to D). The commodity information screen 211 displays the same content as the data stored in the RFID tag 411 of the USB memory 108. In other words, the commodity information screen 211 displays data such as “commodity code,” “commodity name,” “price,” and “push count.”

Furthermore, a price change button 212 labeled “PRICE CHANGE” and a push count clear button 213 labeled “PUSH COUNT CLEAR” are arranged in the lower part of the commodity information screen 211 in a way that they can be touched through the touch panel. If the push count displayed on the commodity information screen 211 is larger than the average and it is determined that the commodity concerned is a “concerned commodity” and some price reduction encourages customers to buy it, the operator touches the price change button 212. As the price change button 212 is touched, a price change screen 221 appears on the LCD 403 as shown in FIG. 12B. Consequently it becomes possible to change the price stored in the RFID tag 411 of the USB memory 108. The price is changed by entering a new price via the keyboard 402. An OK button 222 labeled “OK” and a clear button labeled “CLEAR” are arranged in the lower part of the price change screen 221 in a way that they can be touched through the touch panel. The entered price is cleared by touching the clear button 223. By touching the OK button 222 after entry of a price, communication is started between the RFID tag reader/writer 405 and the RFID tag 411 and the price data stored in the RFID tag 411 is overwritten by the new price data. Then, the commodity information screen 211 is restored on the LCD 403.

When the price is changed, the push count must be cleared. By touching the push count clear button 213 on the restored commodity information screen 211, a push count clear screen 231 appears on the LCD 403 as shown in FIG. 12C. The push count clear screen 231 contains wording such that “Are you sure to clear the push count?”. Thus, compact terminal 401 asks the operator of the compact terminal 401 whether to clear the push count. A clear button 232 labeled “YES” and a clear reject button 233 labeled “NO” are arranged in the lower part of the push count clear screen 231 in a way that they can be touched through the touch panel.

If the clear button 232 is touched, communication is executed between the RFID tag reader/writer 405 and the RFID tag 411. Then, the push count stored in the RFID tag 411 is cleared. If the clear reject button 233 is touched, communication is not started between the RFID tag reader/writer 405 and the RFID tag 411 and the push count stored in the RFID tag 411 is not cleared.

FIG. 12D shows the commodity information screen 211 after price change and push count clearing. By looking at the price change screen 221, the operator of the compact terminal 401 can easily know that the data in the RFID tag 411 of the USB memory 108 has been changed.

The push count stored in the RFID tag 411 of the USB memory 108 can be compared not only with the empirically calculated average but also with the actual quantity sold as data under the POS system (not shown in the Figs.). As described above in connection with the first embodiment, the actual quantity sold is stored as a commodity sales data file 301 in the store controller 311 (FIG. 13) or host computer (not shown the Figs.).

The compact terminal 401 can perform wireless data communication with the store controller 311 through the wireless communication circuit 410.

The RFID tag reader/writer 405 acquires data from the RFID tag 411 of the USB memory 108 and the data is displayed on the LCD 403. The compact terminal 401 executes wireless communication with the store controller 311 according to predetermined operation of the keyboard 402. Then, the compact terminal 401 acquires commodity data, which is corresponding to the commodity code acquired from the RFID tag 411, from the commodity data file 301 stored in the HDD 312 of the store controller 311. The data acquired from the store controller 311 is displayed together with the data acquired from the RFID tag 411 on the LCD 403 (not shown in the Figs.). The data acquired from the RFID tag 411 includes “push count” for the commodity concerned. On the other hand, the data acquired from the store controller 311 includes the actual quantity sold for the same commodity code or same kind of commodity. As for the same commodity code or same kind of commodity, the quantity sold and the push count are compared and if the push count is far larger than the quantity sold, it may be determined that the commodity is a “concerned commodity.”

According to the electronic price tag 101 in this embodiment, the data stored in the USB memory 108 can be changed without removing the USB memory 108 from the electronic price tag 101.

Alternatively, the USB memory 108 of this embodiment may store push flags as in the embodiment shown in FIGS. 1 to 13, instead of push count as information to identify a single operation.

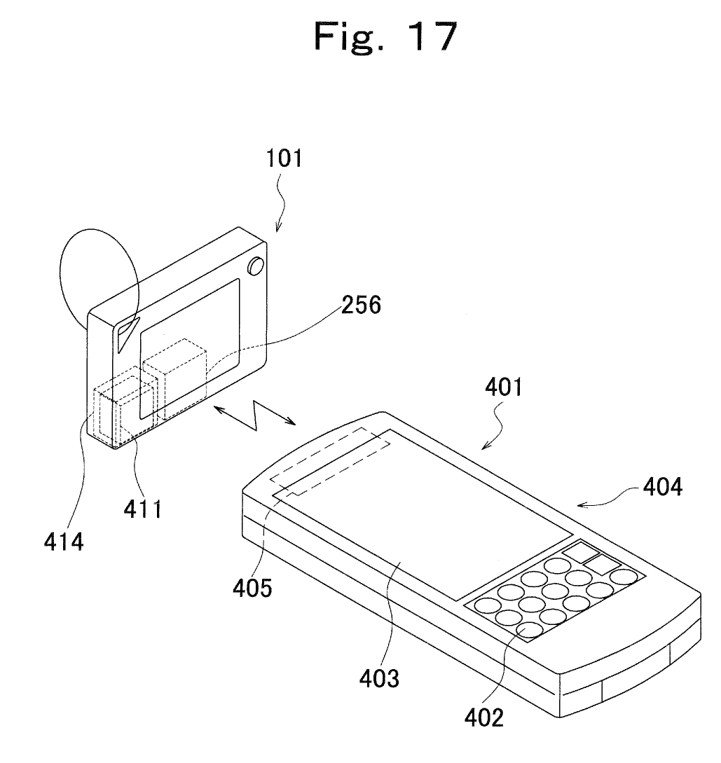

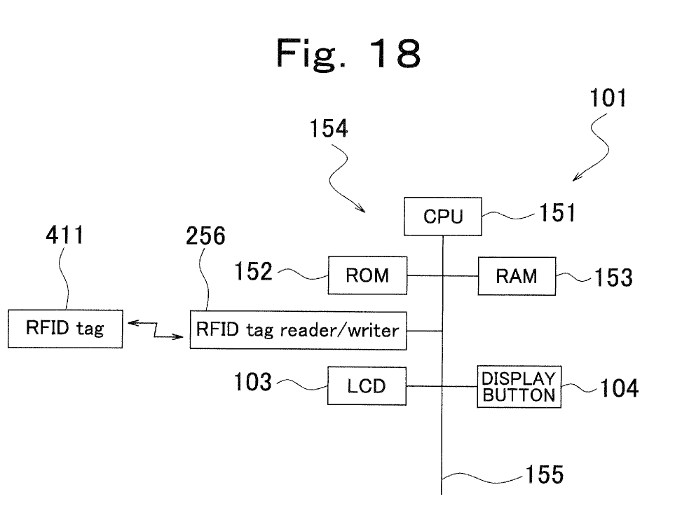

Next, yet another embodiment of the present invention will be described referring to FIGS. 17 and 18.

FIG. 17 is a perspective view showing that an electronic price tag 101 according to another embodiment of the invention can communicate data with a compact terminal 401. The electronic price tag 101 incorporates an RFID tag reader/writer 256 instead of the USB port 156 described in reference to FIG. 14. The electronic price tag 101 has a recess 414 which can house the RFID tag 411. A cover (not shown in the Figs.), which can be detached to place the RFID tag 411 in the recess 414, is attached to the back of the housing of the electronic price tag 101. The RFID tag 411 includes an IC chip (not shown in the Figs.) with a memory, and an antenna which allows wireless data communication (not shown in the Figs.). The antenna of the RFID tag reader/writer 256 is close and opposite to the antenna of the RFID tag 411 with the RFID tag 411 placed in the recess 414. The antenna (not shown in the Figs.) of the RFID tag reader/writer 256 can cover an area opposite and close to it for wireless communications and when they are opposite and close to each other as mentioned above, short-range wireless communications between the RFID tag reader/writer 256 and RFID tag 411 are possible. Wireless communications between the RFID tag reader/writer 256 and the RFID tag 411 may be made by either of the following methods: capacitive coupling, electromagnetic coupling, electromagnetic induction, and microwave communication.

FIG. 18 is a block diagram showing the hardware configuration of the electronic price tag 101 according to another embodiment of the present invention. The RFID tag reader/writer 256 is connected with a CPU 151 through a bus line 155. The microcomputer 154 drives and controls the RFID tag reader/writer 256 and writes data to, and reads data from, the IC chip of the RFID tag 411. Since the hardware elements of the electronic price tag 101 in this embodiment except the RFID tag reader/writer 256 are the same as those of the electronic price tag 101 in the second embodiment described in reference to FIG. 14, their descriptions are omitted.

In order to check the “push count” or “push flags” stored in the RFID tag 411, a person in charge of store management uses a compact terminal 401. The structure of the compact terminal 401 and how it works are the same as in the second embodiment described in reference to FIGS. 15 and 16 and description thereof is omitted.

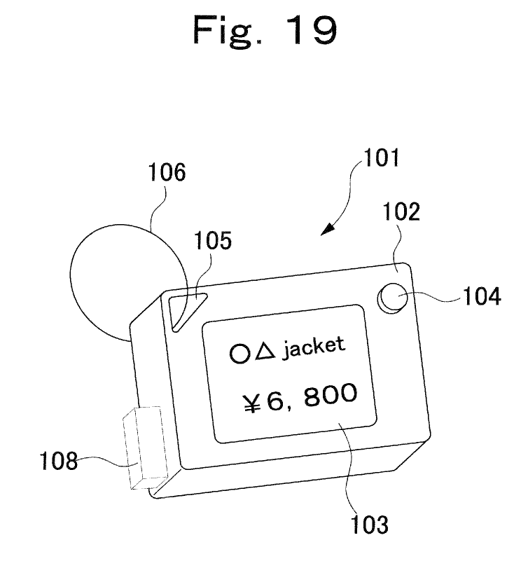

In the foregoing embodiments, the electronic price tag 101 displays only a unit price on the LCD 103 when the display button 104 is pushed. However, the information which is displayed on the LCD 103 by pushing the display button 104 is not limited to unit price. Next, yet another embodiment of the present invention in which information other than unit price is displayed on the LCD 103 will be described referring to FIG. 19.

FIG. 19 is a perspective view of an electronic price tag 101 according to another embodiment in which a price is displayed on the LCD 103. In this embodiment, the commodity name as well as the price is shown on the LCD 103. More specifically, in this embodiment, the microcomputer 154 reads not only the unit price but also the commodity name from the flash memory chip 111 or RFID tag 411 and controls the LCD 103 to display the commodity name as well as the unit price at Step 103 in the flowchart of FIG. 7A, at Step S112 in the flowchart of FIG. 7B, at Step S203 in the flowchart of FIG. 9A, or at Step S212 in the flowchart of FIG. 9B. If the store adopts the electronic price tag 101 according this embodiment, they need not attach any other thing to clothing 11 to indicate the commodity name or they only have to attach the tag 101 to it.

Obviously, numerous modifications and variations of the present invention are possible in light of the above teachings. It is therefore to be understood that within the scope of the appended claims, the invention may be practiced otherwise than as specifically described herein.

What is claimed is:

1. An electronic price tag comprising:
a display which has an information display function;
an operating part which is operated by a user;
a data transceiver which allows connection of a storage with a nonvolatile memory storing data including a commodity price in a rewritable manner and executes data transmitting to the storage and data receiving from the storage; and
a control section which executes:
a process of storing information to identify a single operation, in the nonvolatile memory of the storage in response to a predetermined operation at the operating part; and
a process of reading price data stored in the nonvolatile memory of the storage in response to the predetermined operation at the operating part and controlling the display to display a price based on the read price data for a predetermined time.

2. The electronic price tag according to claim 1, wherein the nonvolatile memory is an RFID tag's IC chip.

3. The electronic price tag according to claim 2,
wherein the data transceiver electrically connects the RFID tag's IC chip with the control section; and
wherein the control section executes data reading from the IC chip and data writing to the IC chip.

4. The electronic price tag according to claim 2,
wherein the data transceiver is an RFID tag reader/writer; and
wherein the control section controls the RFID tag reader/writer to execute data reading from the IC chip and data writing to the IC chip.

5. The electronic price tag according to claim 1,
wherein the storage has a connector; and
wherein the data transceiver is a port to which the connector is connected.

6. The electronic price tag according to claim 5,
wherein the storage is a USB memory; and
wherein the port is a USB port.

7. The electronic price tag according to claim 1,
wherein the information to identify a single operation is the number of times of operation of the operating part; and
wherein the process of storing the information to identify a single operation is a process of incrementing the number of times of operation stored in the nonvolatile memory.

8. The electronic price tag according to claim 7,
wherein the control section executes the process of incrementing the number of the times of operation stored in the nonvolatile memory after passing the predetermined time for displaying the price.

9. The electronic price tag according to claim 1,
wherein the information to identify a single operation is a status signal to identify a single operation; and
wherein the process of storing the information to identify a single operation is a process of additionally storing the status signal in the nonvolatile memory.

10. The electronic price tag according to claim 9,
wherein the control section executes the process of additionally storing the status signal in the nonvolatile memory after passing the predetermined time for displaying the price.

11. The electronic price tag according to claim 1,
wherein the data stored in the nonvolatile memory includes a commodity code to identify a commodity.

12. The electronic price tag according to claim 1,
wherein the data stored in the nonvolatile memory includes a commodity name; and
wherein the control section reads commodity name data stored in the nonvolatile memory in response to the predetermined operation at the operating part and controls the display to display a commodity name based on the read commodity name data together with the price for a predetermined time.

13. The electronic price tag according to claim 1,
wherein the operating part is a button; and
wherein the predetermined operation is pushing the button.

14. The electronic price tag according to claim 1,
wherein the control section executes the process of storing the information to identify a single operation in the nonvolatile memory after passing the predetermined time for displaying the price.
